(19) United States
(12) Patent Application Publication
(10) Pub. No.: US 2017/0126898 A1
(43) Pub. Date: May 4, 2017

(54) TRANSMISSION OF DATA WITH VOICE-ENCODED DATA UNITS ON A WIRELESS COMMUNICATIONS CHANNEL USING VARIABLE RATE BIT STEALING

(71) Applicant: MOTOROLA SOLUTIONS, INC., Schaumburg, IL (US)

(72) Inventors: Robert MROWIEC, Liszki (PL); Mariusz WAWROWSKI, Wawrzenczyce (PL)

(21) Appl. No.: 15/104,515

(22) PCT Filed: Apr. 24, 2015
(86) PCT No.: PCT/PL2015/050012

§ 371 Date: Jun. 14, 2016

(51) Int. Cl. H04M 11/06; H04W 4/02; H04B 17/382; H04B 7/26

(52) U.S. Cl. CPC H04M 11/06; H04B 7/2621; H04W 4/027; H04B 17/382

(57) ABSTRACT

A method and apparatus transmits data with voice-encoded data units on a wireless communications channel with a voice transmission. The arrangement determines a number of audio bits available for stealing by analyzing at least one parameter that affects voice quality selected from the group of: a movement velocity of the mobile communication radio, a signal strength or fading rate of the radio channel, a location of the mobile communication radio with respect to a coverage map, whether the mobile communication radio is disposed in an indoor location, and a distance from the communication radio to the base radio. The determination is provided to an audio and data coding profile. The profile is applied to substitute data bits for the determined number of audio bits in one or more voice-encoded data units and the mobile radio transmits the voice-encoded data units with the voice transmission.

### BACKGROUND OF THE INVENTION

Wireless communication systems may be designed to conform to various communication protocols and standards, including, without limitation, for example, Project 25 (P25), Terrestrial Trunked Radio (TETRA), Digital Mobile Radio (DMR), Public Safety Long Term Evolution (PSLTE), and others. In many instances, a communication device (for example, a two-way radio) that is operating on the voice channel of such a communication system must leave that channel in order to transmit data.

One mechanism for allowing both voice and data transmission over the same channel is known as “bit stealing.” Generally, bit stealing involves using bits that are normally assigned, for example, to carry control or signaling information to carry communication information, such as text data, sensor data, or other data so that both voice and data may be sent on the same channel. Although, the broad concept of bit stealing is known, transmitting both voice and data on a single communication channel still presents challenges.

Accordingly, there is a need to provide transmission of data with voice-encoded data units on a wireless communications channel using variable bit rate stealing.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a block diagram of a logical data unit in accordance with an embodiment.

FIG. 2 illustrates a block diagram of a logical data unit in accordance with an embodiment.

FIG. 3 illustrates a block diagram of an exemplary implementation of a mobile communication radio in accordance with some embodiments.

FIG. 4 illustrates a block diagram of a base radio and inputs provided to a mobile communication radio in accordance with some embodiments.

FIG. 5 illustrates an operative diagram for a mobile communication radio and a base radio in accordance with some embodiments.

FIG. 6 illustrates a block diagram of a logical data unit in accordance with an embodiment of bit stealing.

FIG. 7 illustrates a block diagram of another logical data unit for carrying stolen bits.

FIG. 8 illustrates an XMBE frame for carrying stolen bits.

FIG. 9 illustrates an operative diagram for mobile communication radios and a base radio.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In an exemplary embodiment, a method for transmission of data with voice-encoded data units on a wireless communications channel includes determining a number of audio bits available for stealing by analyzing at least one parameter that affects voice quality selected from the group consisting of a movement velocity of the mobile communication radio, a signal strength or a fading rate of the wireless communications channel, a location of the mobile communication radio with respect to a coverage map, an indoor location for the mobile communication radio, and a distance from the mobile communication radio to the base radio. The method also includes providing the determined number of audio bits available to a preconfigured audio and data coding profile; applying the audio and data coding profile to substitute data bits for the determined number of audio bits for stealing in the one or more voice-encoded data units; and transmitting the one or more voice-encoded data units with the voice transmission.

In another exemplary embodiment, a method for transmission of data with voice-encoded data units on a wireless communications channel includes determining a movement velocity of the mobile communication radio, determining a number of audio bits available for stealing by analyzing the movement velocity of the mobile communication radio, substituting data bits for the determined number of audio bits for stealing in one or more of the voice-encoded data units, and transmitting the one or more voice-encoded data units with the voice transmission.

Another exemplary embodiment provides a mobile communication radio. The mobile communication radio may include a wireless network interface; an antenna; a processor communicatively coupled to the wireless network interface; and a memory storing instructions, including an audio and data coding profile that, when executed, cause the processor to determine a number of audio bits available for stealing by analyzing at least one parameter that affects voice quality selected from the group consisting of a movement velocity of the mobile communication radio, a signal strength or a fading rate of a radio channel, a location of the mobile communication radio with respect to a coverage map, an indoor location for the mobile communication radio, and a distance from the mobile communication radio to the base radio. The instructions cause the processor to provide the determined number of audio bits to a preconfigured audio and data coding profile; apply the audio and data coding profile to substitute data bits for the determined number of audio bits for stealing in one or more voice-encoded data units; and provide the voice-encoded data units to a transceiver for transmitting the one or more voice-encoded data units with the voice transmission on the radio channel.

In various exemplary embodiments, voice and data systems and methods are described that “steal bits” from voice-encoded data units, such as voice frames and/or embedded signaling segments. In this manner, concurrent voice and data transmission is supported over protocols that are otherwise designed for or typically provide only voice transmission. In certain embodiments, the stealing of bits from voice is done in a manner that is transparent and not noticeable to users. Without a loss of generality, this disclosure is described in more detail with a reference to a particular use, sending periodic location updates over a P25 Frequency Division Multiple Access (FDMA) system (sometimes referred to as “Phase 1 P25” or “Phase 1” hereafter). The proposed mechanisms described herein, are also applicable to other use cases as well as other wireless air interfaces such as P25 Time Division Multiple Access (TDMA) (sometimes referred to as “Phase 2 P25” or “Phase 2” hereafter), Terrestrial Trunked Radio, Digital Mobile Radio, and others.

In one instance, an exemplary end user demand utilizes subscriber radios that enter an emergency mode are able to transmit relatively frequent location updates, without leaving the voice channel while in normal operation, and without introducing any additional delays or substantial audio truncation during call setup. In all of these scenarios, a conventional P25 radio cannot send mission critical data while currently transmitting voice.

One embodiment utilizes a P25 FDMA or Phase 1 protocol data unit (PDU) and an internet protocol (IP) datagram. The IP datagram is utilized to support location applications (e.g., Global Positioning System (GPS), Global Navigation Satellite System (GLONASS), Compass, Galileo, etc.). A protocol data unit includes user data which includes data blocks, a header block, an end block, and cyclic redundancy check (CRC) data. An internet protocol (IP) datagram includes GPS application data, a user datagram protocol (UDP) header, an IP header, and a sub network data convergence protocol (SNDCP) header. The concurrent voice and data systems and methods described herein enable, in an exemplary embodiment, a transmitting P25 subscriber radio to support voice and packet data services concurrently.

As noted, one proposed mechanism for concurrent use of the channel takes advantage of P25 standard protocols and message structure to enable transport of an IP datagram within a protocol data unit. While GPS data is described as an exemplary piece of data that may be transmitted in accordance with the disclosed methods and systems, in other embodiments, other types of data may be transmitted.

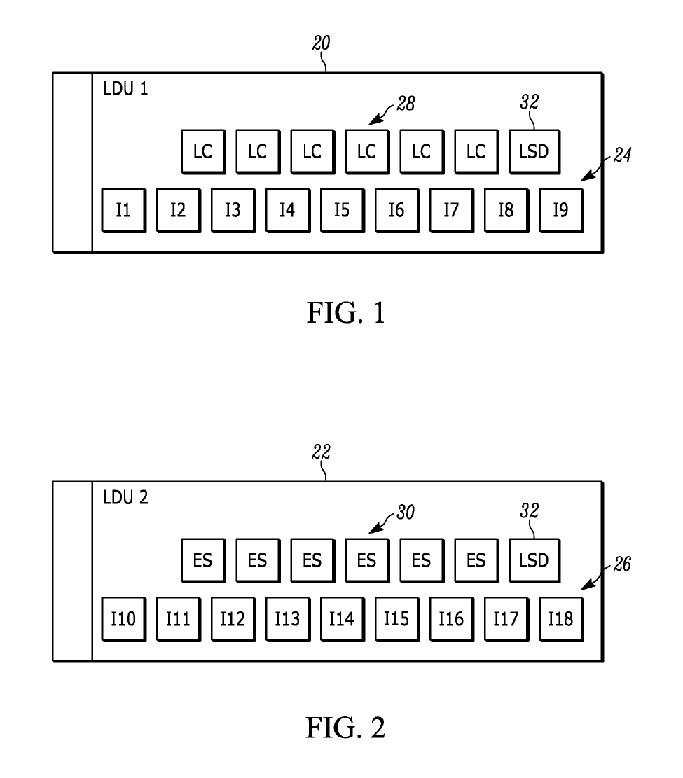

FIGS. 1 and 2 are block diagrams of P25 FDMA or Phase 1 logical data units (LDUs) 20, 22 in accordance with some embodiments. The P25 standards define embedded link control signaling within the FDMA voice stream. The standards provide a framework where new link control (LC) messages can be added. A single link control message 28 is sent every 360 milliseconds (milliseconds), and contains 9 bytes of user data (before error coding). One of ordinary skill in the art would appreciate that it would be inefficient to embed a packet data unit within the link control messages, due to the relatively slow update rate. For example, a typical GPS location packet data unit includes 72 bytes (before error coding), and it would take over 2.5 seconds to send this packet data unit within the link control messages. In addition, this approach is likely to have relatively low reliability unless additional error coding were added (which would further increase the transmission time). The P25 standard also defines embedded low speed data (LSD) signaling 32 with the FDMA voice stream. There are 4 bytes of user data (before error coding) that are sent every 360 milliseconds. Low speed data is over four times slower than link control messages.

Each of the logical data units 20, 22 shown in FIGS. 1 and 2 include a frame synch and network identification header with the network ID being a network access code (NAC) and a data unit ID (DUID). Each P25 FDMA logical data unit 20, 22 includes nine frames of voice-encoded data frames, such as multi-band excitation voice frames 24, 26 (labeled in FIG. 1 as I1 through I9 and in FIG. 2 as I10 through I18). The voice encoder for P25 FDMA voice is Improved Multi-Band Excitation (IMBE). Each improved multi-band excitation voice frame 24, 26 contains 20 milliseconds of audio, and includes 144 bits (including error coding). For embedded signaling segments, the logical data unit 20 includes six segments of link control messages 28 and the logical data unit 22 includes six segments of encryption sync (ES) 30, where the sum of all embedded signaling segments within the logical data unit includes 240 bits (including error coding). The logical data units 20, 22 each have a serialization time of 180 milliseconds on the FDMA P25 wireless air interface. Each logical data unit 20, 22 also includes a 32 bit low speed data 32 field (including error coding).

A P25 TDMA or Phase 2 air interface, while structured differently from the P25 FDMA air interface, is also divided among voice frames, a general-purpose signaling field (“IEMI”), and Encryption Sync fields. The voice frames each contain 72 bits and 20 milliseconds of audio. The general-purpose signaling field carries media access control (MAC) messages instead of link control messages (276 bits) and the Encryption Sync fields each carry 264 bits every 360 milliseconds. Phase 2 does not have any equivalent of Phase 1's low speed data field. The concurrent voice and data systems and methods described herein apply to P25 Phase 1 (FDMA), P25 Phase 2 (TDMA), and other wireless air interfaces as well.

Embodiments of the methods disclosed herein replace information allocated to certain fields within messages carried over the wireless air interface with data packets including data bits of a specific service. Certain embodiments also replace audio bits with data bits while providing reduced impact to quality of operation and little, if any, conflict with P25 standards of voice channel interoperability.

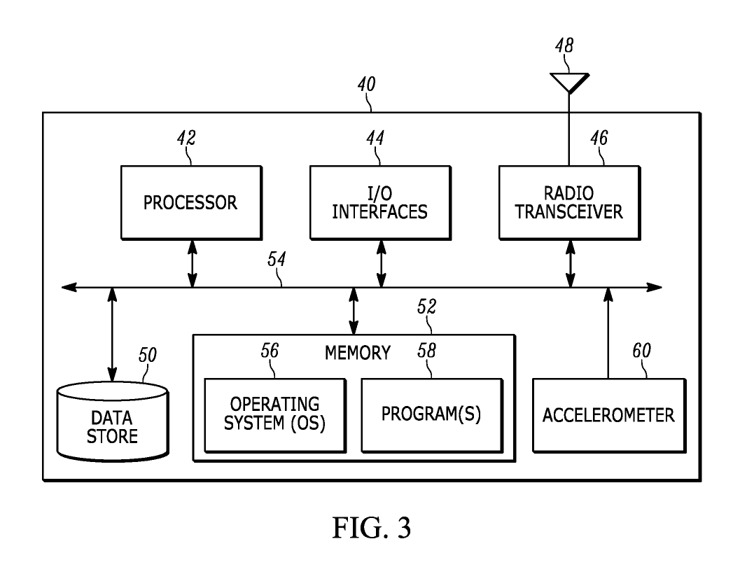

FIG. 3 is a block diagram of an exemplary implementation of a mobile communication radio 40, in accordance with some embodiments. The mobile communication radio 40 can be a digital device that, in terms of hardware architecture, generally includes a processor 42, input/output (I/O) interfaces 44, a transceiver 46 connected to an antenna 48, a data store 50, and memory 52. It should be appreciated by those of ordinary skill in the art that FIG. 3 depicts the mobile communication radio 40 in an oversimplified manner, and a practical embodiment can include additional components and suitably configured processing logic to support known or conventional operating features that are not described in detail herein. The components (processor 42, input/output interface 44, transceiver 46, antenna 48, data store 50 and memory 52) are communicatively coupled via a local interface 54. The local interface 54 can be, for example but is not limited to, one or more buses or other wired or wireless connections, as is known in the art. The local interface 54 can have additional elements, which are omitted for simplicity, such as controllers, buffers (caches), drivers, repeaters, and receivers, among many others, to enable communications. Further, the local interface 54 may include address, control, and/or data connections to enable appropriate communications among the aforementioned components.

The processor 42 is a hardware device for executing software instructions. When the mobile communication radio 40 is in operation, the processor 42 is configured to execute software stored within the memory 52, to communicate data to and from the memory 52, and to generally control operations of the mobile communication radio 40 pursuant to the instructions of the software. In an exemplary embodiment, the processor 42 may include a mobile optimized processor such as optimized for power consumption and mobile applications. The I/O interfaces 44 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display, touch screen, and the like. The I/O interfaces 44 can also include, for example, a serial port, a parallel port, a small computer system interface, an infrared interface, a radio frequency interface, a universal serial bus interface, and the like. The I/O interfaces 44 can include a graphical user interface that enables a user to interact with the mobile communication radio 40.

The radio transceiver 46 includes a transmitter and receiver that enable two-way wireless communication to an external access device or network. Any number of suitable wireless data communication protocols, techniques, or methodologies can be supported by the radio transceiver 46, including, without limitation: RF; LMR; IrDA (infrared); Bluetooth; ZigBee (and other variants of the Institute of Electrical and Electronics Engineers (IEEE) 802.15 protocol); IEEE 802.11 (any variation); IEEE 802.16 (WiMAX or any other variation); Direct Sequence Spread Spectrum; Frequency Hopping Spread Spectrum; LTE; cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the Wireless Medical Telemetry Service (WMTS) bands; General Packet Radio Service (GPRS); P25; TETRA, DMR, proprietary wireless data communication protocols such as variants of Wireless USB; and any other protocols for wireless communication.

The data store 50 can include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 50 can incorporate electronic, magnetic, optical, and/or other types of storage media.

The memory 52 can include any of volatile memory elements, and combinations thereof, as set forth above with respect to the data store 50. Note that the memory 52 can have a distributed architecture, where various components are situated remotely from one another, but can be accessed by the processor 42. The software in memory 52 can include one or more software programs, each of which includes an ordered listing of executable instructions for implementing logical functions. In the example of FIG. 3, the software in the memory 52 includes a suitable operating system (O/S) 56 and programs 58. The operating system 56 essentially controls the execution of other computer programs, and provides input-output control, file and data management, memory management, and communication control and related services. The programs 58 can include various applications, add-ons, etc. configured to provide end user functionality with the mobile communication radio 40.

In the embodiment shown in FIG. 3, the mobile communication radio 40 includes an accelerometer 60. The accelerometer 60 provided information that may be used to determine a movement velocity of the mobile communication radio 40. The accelerometer 60 is an optional component. In other embodiments, movement velocity of the mobile communication radio is assumed to correlate to vehicle velocity measured by a vehicle velocity sensor disposed within the vehicle. In such an instance, the vehicle velocity sensor provides an input to one of the input/output interfaces 44. GPS signals can also be processed to determine the movement velocity 64 for the mobile communication radio 40.

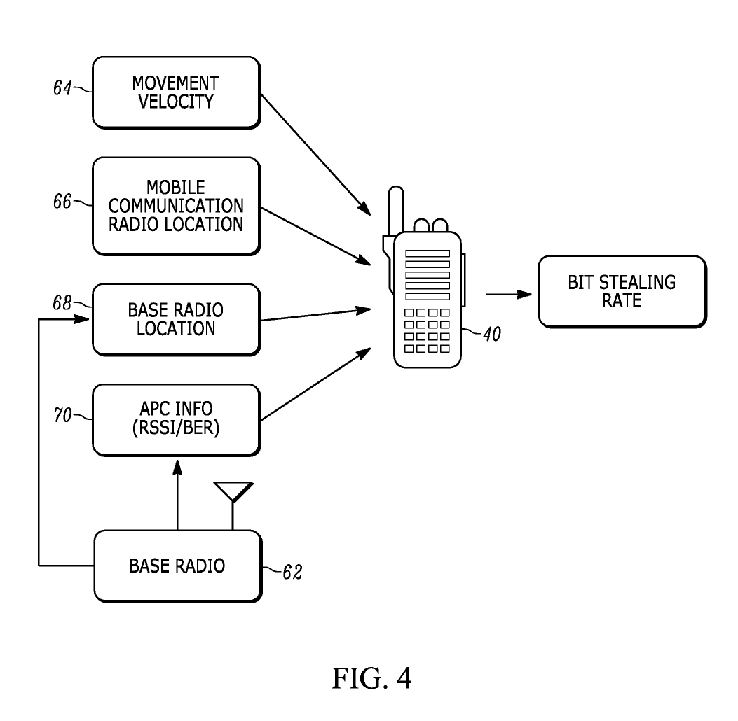

FIG. 4 shows a base radio 62 and inputs received by the mobile communication radio 40 to determine a bit stealing rate. As set forth above, the mobile communication radio 40 receives a movement velocity 64 measurement from an accelerometer 60 in one embodiment and from a vehicle velocity sensor in another embodiment. The movement velocity 64 for the mobile communication radio is used to determine a Doppler frequency shift that corresponds to fading of a radio frequency (RF) transmission. Likewise, Rayleigh fading may occur for an antenna moving at constant velocity. Fading is most significant with respect to RF signals between about 3 miles per hour (mph) and about 7 miles per hour (mph), and more specifically at or about 5 mph.

In another embodiment, a mobile communication radio location 66 is obtained by the mobile communication radio 40. In some embodiments, the radio location 66 is determined by a GPS provided with the mobile communication radio 40. Finally, the radio location 66 is also determined by a vehicle GPS signal for a vehicle including the mobile communication radio 40.

In another embodiment, the location of the mobile communication radio 40 is determined at the base radio 62 by triangulation and sent from the base radio to the mobile communication radio.

In one embodiment, a base radio location 68 is provided to the mobile communication radio 40 from wireless signals from the base radio 62. From the location, a distance therefrom is determined.

Adaptive power control (APC) information 70 is also provided to the mobile communication radio 40 from wireless signals from the base radio 62 for the voice radio channel being used for communications. The APC information is related to Received Signal Strength Information (RSSI) and Bit Error Rate (BER) determined by a processor of the base radio 62 or a server connected to the base radio. Thus, the APC information describes the signal strength of the communication between the base radio 62 and the mobile communication radio 40.

In some embodiments, the base radio 62 connects to a server (not shown). The server can include or be part of the functionality of multiple base radios 62, a site controller, or similar device. The server can be a digital computer that, in terms of hardware architecture, includes a processor, input/output (I/O) interfaces, a network interface, a data store, and a memory. It should be appreciated by those of ordinary skill in the art a practical embodiment may include additional components and suitably configured processing logic to support known or conventional operating features that are not described in detail herein. The components of the arrangement are communicatively coupled via a local interface.

Mobile Communication Radio Operation

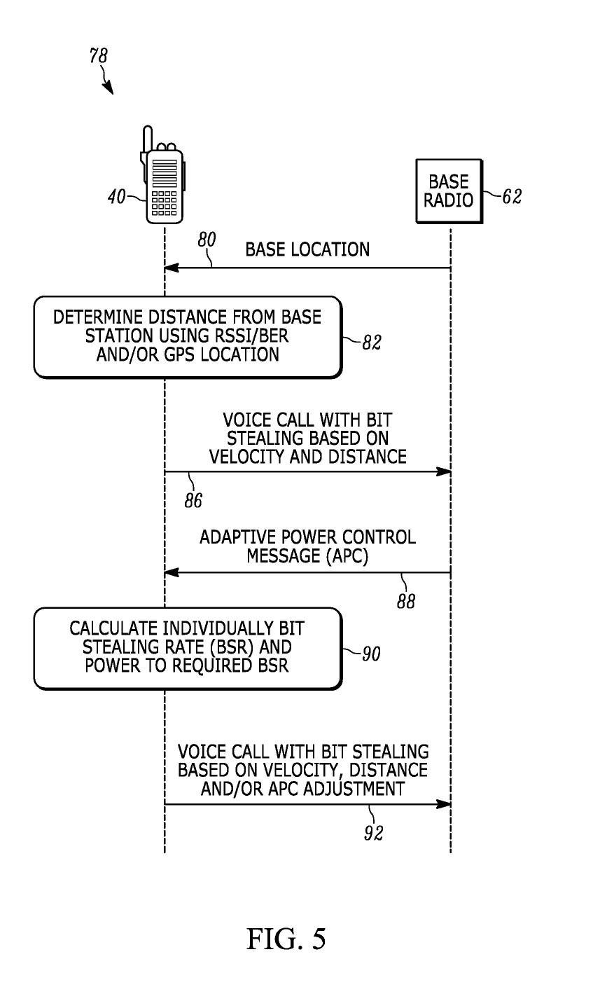

FIG. 5 shows an operational diagram 78 for communication between a mobile communication radio 40 and a base radio 62 or a broadcast transceiver that acts as a communication link for the base radio 62. For purposes of this illustrated example, in some embodiments, a tower or other transmission infrastructure may be considered a part of the base radio 62.

In FIG. 5, at operation 80 the base radio 62 transmits the base radio location 68 to the mobile communication radio 40. At operation 82, the processor 42 of the mobile communication radio 40 determines a distance from the base radio 62 using RSSI/BER and/or a GPS location of the mobile communication radio in combination with the base radio location 68.

Further, the mobile communication radio 40 determines or receives a movement velocity or movement speed thereof. Based on the movement velocity and the distance, a number of bits for stealing is determined. Optimally, the number of bits for stealing has minimal impact on the voice quality. The number of bits is variable, and is reduced based on factors. For example, when the velocity is between about 3 miles per hour and about 7 miles per hour, the number of bits is reduced.

When a voice call is uplinked by a user with the mobile communication radio 40 at operation 86 in FIG. 5, the determined number of encoded audio or voice bits for stealing is substituted with data bits in one or more voice-encoded data units. The data bits typically represent location updates for the mobile communication radio. The voice call on the voice radio channel is transmitted with voice-encoded data units including the data bits from the mobile communication radio 40 to the base radio 62 as an uplink transmission.

As shown in FIG. 5, in another transmission at operation 88, the base radio 62 provides an adaptive power control (APC) value to the mobile communication radio 40. The mobile communication radio 40 then, at operation 90, calculates or determines a bit stealing rate (BSR) for a number of audio bits to be stolen in view of the power or signal strength corresponding to the adaptive power control value.

As shown in FIG. 5, in providing another voice call at operation 92, the mobile communication radio 40 performs bit stealing based on velocity, a distance and/or an APC value. The APC value changes when the mobile communication radio 40 moves to another location. Otherwise, the APC value stays the same. The voice call transmits voice-encoded units including the data bits from the mobile communication radio 40.

Bit Stealing Embodiments

The number of stolen bits and the processing and sending of data bits within voice-encoded data units in the arrangement of FIG. 5 is performed in various ways.

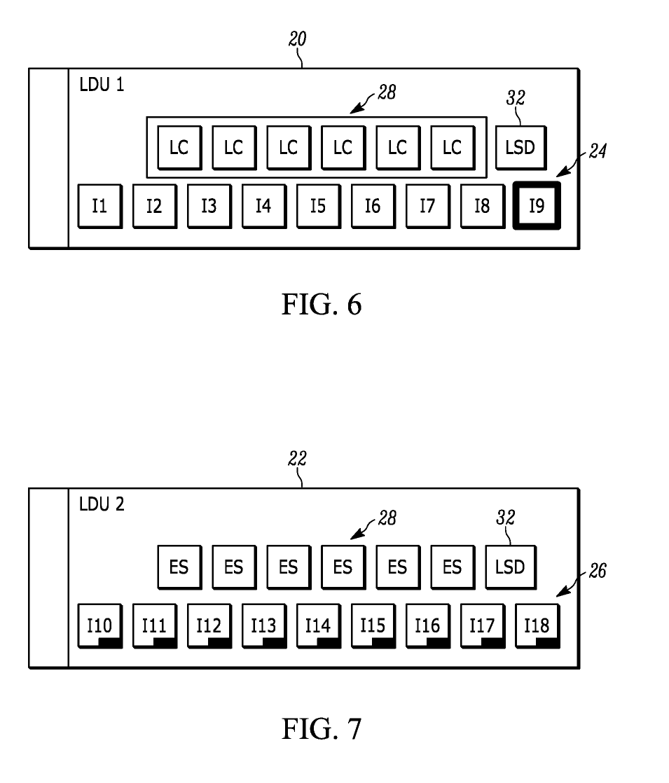

A preconfigured audio and data coding profile creates logical data unit 20 as a voice-encoded data unit that includes bit stealing information on one or more of the link control messages 28 that indicates the number of data bits and includes data bits within the voice frame or voice frames I1-I9 as shown in FIG. 6. In the FIG. 6 arrangement, the entire voice frame 19 is provided as data bits by the audio and data coding profile executed on the processor 42 (See FIG. 3).

Thereafter, the base radio 62 receives logical data unit 20 transmitted by the mobile communication radio 40. The base radio 62 reads from a link control message 28 of logical data unit 20 that the frame 19 contains only data bits. Therefore, the processor or a server provided with the base radio 62 ignores frame 19 in providing a voice output. Instead, the base radio 62 reads the data in frame 19 to determine a location of the mobile communication radio 40, or other data, such as an image, or a text message. In one embodiment, the message in a link control message is indicating that at least one voice frame stores the data bits in a first logical unit and the data bits represent the location of the mobile communication radio 40. An image or text message is sent over a plurality of logical data units 20 and logical data units 22 as voice-encoded data units. While one voice frame 19 is stolen for data purposes in its entirety, additional voice frames are contemplated.

In another embodiment shown in FIG. 7, logical data unit 22 is a voice-encoded data unit. In this embodiment, bit stealing information for logical data unit 22 is provided on one or more of the link control messages 28 of the previous logical data unit 20. Thus, a processor of the base radio 62 knows what voice frame or frames I10-I18 include data bits upon receipt of the voice-encoded data unit. In the FIG. 7 arrangement, voice frames I10-I18 each include 7 data bits. Thus, the base radio 62 that receives logical data unit 22 reads the data bits from each of the voice frames 26.

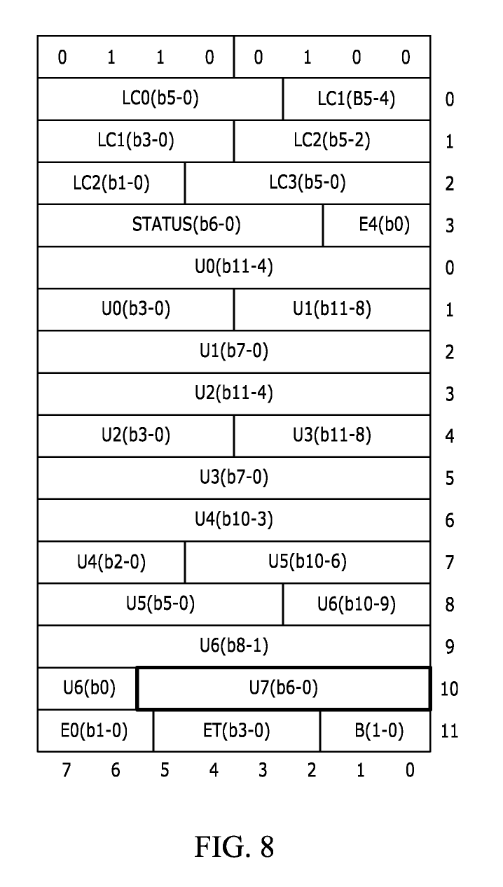

In one embodiment, each of the voice frames 26 is an XMBE frame as shown in FIG. 8. An XMBE frame is a frame that is used with P25 Phase 2 and other protocols. The XMBE frame stores voice data (i.e., either Improved Multi-Band Excitation (IMBE) or Advanced Multiband Excitation (AMBE)), Link control (LC), Encryption Synchronization (ES), and Low Speed Data (LSD). In FIG. 8, the stolen bits are taken at U7. While 7 bits are stolen, any number of bits from none to 7 can be stolen depending on RF conditions.

Thereafter, the processor or a server provided with the base radio 62 ignores a portion of each of the voice frames 26 in providing a voice output. Instead, the base radio 62 reads the data in the portion of each of the voice frames 26 to determine a location of the mobile communication radio 40, or other information therefrom. While 7 bits is stolen from each voice frame 26 as shown in FIGS. 7 and 8, a determination of weak signal strength or a great distance from the mobile communication radio 40 to the base radio 62 may result in the stealing of only 4 bits from each voice frame. 26. Thus, the number of bits stolen is variable. While an arrangement wherein the determined number of bits available for stealing comprises one of a first number of bits (4) and a second greater number of bits (7) is disclosed, other arrangements, wherein more than two different numbers of bits are selectively stolen are contemplated.

Multiple Mobile Communication Radios Operation

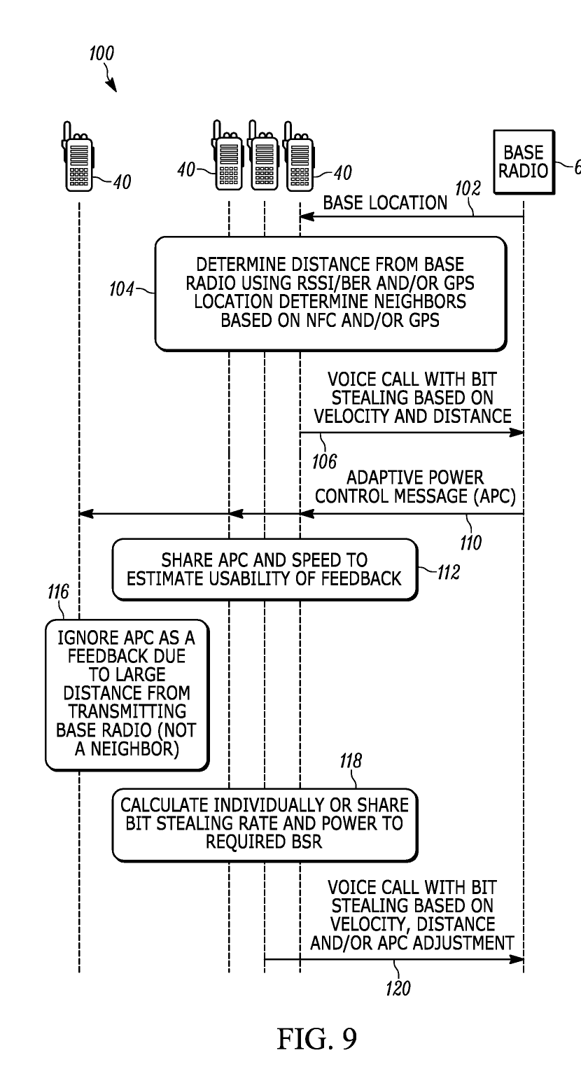

FIG. 9 shows an operational diagram 100 for communication between mobile communication radios 40 and a base radio 62 or a broadcast transceiver that acts as a communication link for the base radio 62.

In FIG. 9, the base radio 62 transmits the base location to the mobile communication radios 40 at operation 102. The processor 42 of each of the mobile communication radios 40 determines a distance from the base radio 62 using RSSI/BER and/or a GPS location of the mobile communication radio in combination with the base location at operation 104.

Further, each of the mobile communication radios 40 shown in FIG. 5 determines or receives a movement velocity or movement speed thereof. Based on the movement velocity and the distance, a number of bits for stealing is determined. Further, each of the mobile communication radios 40 determines the presence or absence of neighboring mobile communication radios based on near field communication (NFC) and/or GPS signals.

When a voice call is made by users with the mobile communication radios 40 at operation 106 in FIG. 9, the processor 42 operates to substitute data bits corresponding to the determined number of encoded audio or voice bits for stealing with audio or voice bits in one or more voice-encoded data units. Thus, the voice calls on the voice radio channel are transmitted with voice-encoded data units including the data bits from each of the mobile communication radios 40 to the base radio 62.

As shown in FIG. 9, in another transmission, the base radio 62 provides an adaptive power control (APC) value to the mobile communication radios 40 at operation 110. Each of the neighboring mobile communication radios 40 then share the APC value, and in combination with velocity, estimate the usefulness of the feedback at operation 112.

Due to the remote distance of the furthest one of the mobile communication radios 40 shown in FIG. 9, at operation 116 the APC value thereat is ignored doe to the long distance from a transmitting mobile communication radio 40.

At operation 118 in FIG. 9, the neighboring mobile communication radios 40 then calculate or determine a bit stealing rate either individually or share the bit stealing rate in view of the power or signal strength corresponding to the adaptive power control value.

As shown in FIG. 9, in providing another voice call at operation 120, the mobile communication radios 40 perform bit stealing based on velocity, a distance and/or an APC value.

In some embodiments, different factors determine the number of audio or voice bits available for stealing. For instance, in one embodiment the processor 42 of the mobile communication radio 40 determines a location of the mobile communication radio 40 relative to a coverage map.

In some embodiments, the processor 42 of the mobile communication radio 40 determines whether the mobile communication radio is disposed in an indoor location by the absence of a GPS signal or other similar signals.

Further, in some embodiments the processor 42 of the mobile communication radio 40 determining a number of audio bits available for stealing requires the analyzing of at least one parameter that affects voice quality selected from the group of: a movement velocity of the mobile communication radio 40, a signal strength or fading rate of the radio voice channel, a location of the mobile communication radio with respect to a coverage map, and whether the mobile communication radio is disposed in an indoor location.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method for transmission of data with voice-encoded data units on a wireless communications channel, the method comprising:
determining a number of audio bits available for stealing by analyzing at least one parameter that affects voice quality selected from the group consisting of a movement velocity of the mobile communication radio, a signal strength or a fading rate of the wireless communications channel, a location of the mobile communication radio with respect to a coverage map, an indoor location for the mobile communication radio, and a distance from the mobile communication radio to the base radio;
providing the determined number of audio bits available to a preconfigured audio and data coding profile;
applying the audio and data coding profile to substitute data bits for the determined number of audio bits for stealing in the one or more voice-encoded data units; and
transmitting the one or more voice-encoded data units with the voice transmission.

2. The method according to claim 1, further comprising:
determining the movement velocity of the mobile communication radio;
determining the signal strength or the fading rate of the wireless communications channel between the mobile communication radio and the base radio at the base radio and transmitting the signal strength to the mobile communication radio; and
the determining of the number of audio bits for stealing is determined by at least the movement velocity of the mobile communication radio and the signal strength or the fading rate of the wireless communications channel,
wherein the transmission of data bits with the voice-encoded data units on the wireless communications channel includes an uplink transmission.

3. The method according to claim 2, wherein the determining of the number of audio bits for stealing is determined by at least the movement velocity of the mobile communication radio and the signal strength or the fading rate of the wireless communications channel,
wherein the determining of the number of audio bits for stealing and providing to the preconfigured audio and data coding profile is performed by the mobile communication radio.

4. The method according to claim 3, further comprising:
determining the location of the mobile communication radio relative to the coverage map; and
the determining of the number of audio bits for stealing is determined by at least the movement velocity of the mobile communication radio, the signal strength or the fading rate of the wireless communications channel, and the location of the mobile communication radio relative to the coverage map.

5. The method according to claim 4, wherein the location of the mobile communication radio is determined at the base radio by triangulation and sent from the base radio to the mobile communication radio.

6. The method according to claim 1, wherein the determined number of audio bits available for stealing is one of a first number of audio bits and a second greater number of audio bits.

7. The method according to claim 2, wherein the number of audio bits for stealing is reduced at least when the movement velocity of the mobile communication radio is between about 3 miles per hour and about 7 miles per hour.

8. The method according to claim 1, wherein the movement velocity is a vehicle velocity that is provided to the mobile communication radio by a vehicle velocity sensor, and wherein the mobile communication radio is disposed within a vehicle.

9. The method according to claim 1, wherein the one or more voice-encoded data units are logical data units, and
the applying of the audio and data coding profile to substitute data bits for the determined number of audio bits for stealing includes substituting data bits for the determined number of audio bits in at least a portion of at least one voice frame of the one or more logical data units.

10. The method according to claim 9, wherein the applying of the audio and data coding profile includes providing a message in a first one of the logical data units indicating the at least one voice frame of a second one of the logical data units storing data bits.

11. The method according to claim 9, wherein the applying of the audio and data coding profile includes providing a message in a link control message of a first one of the logical data units indicating the at least one voice frame storing data bits in a first of the logical data units, and wherein data bits represent the location of the mobile communication radio.

12. The method according to claim 1, wherein the determining of the movement velocity of the mobile communication radio is determined by an accelerometer provided with the mobile communication radio.

13. A method for transmission of data with voice-encoded data units on a wireless communications channel comprising:
determining a movement velocity of the mobile communication radio;
determining a number of audio bits available for stealing by analyzing the movement velocity of the mobile communication radio;
substituting data bits for the determined number of audio bits for stealing in one or more of the voice-encoded data units; and
transmitting the one or more voice-encoded data units with the voice transmission.

14. The method according to claim 13, wherein the data bits indicate a location of the mobile communication radio and the voice transmission is an uplink transmission.

15. The method according to claim 13, further comprising determining signal strength or fading rate of the wireless communications channel between the mobile communication radio and the base radio; and
the determining of the number of audio bits available for stealing includes analyzing the movement velocity, the signal strength, and the fading rate of the wireless communications channel.

16. The method according to claim 15, further comprising:
determining when the mobile communication radio is disposed in an indoor location; and
the determining of the number of audio bits available for stealing includes analyzing the movement velocity, the signal strength, the fading rate of the wireless communications channel, and whether the mobile communication radio is in an indoor location.

17. A mobile communication radio comprising:
a wireless network interface and an antenna;
a processor communicatively coupled to the wireless network interface; and
a memory storing instructions, including an audio and data coding profile that, when executed, cause the processor to:
determine a number of audio bits available for stealing by analyzing at least one parameter that affects voice quality selected from the group consisting of a movement velocity of the mobile communication radio, a signal strength or a fading rate of a radio channel, a location of the mobile communication radio with respect to a coverage map, an indoor location for the mobile communication radio, and a distance from the mobile communication radio to the base radio;
provide the determined number of audio bits to a preconfigured audio and data coding profile;
apply the audio and data coding profile to substitute data bits for the determined number of audio bits for stealing in one or more voice-encoded data units; and
provide the one or more voice-encoded data units with the voice transmission to a transceiver for transmitting on the radio channel.

18. The mobile communication radio of claim 17, wherein the memory stores the instructions that, when executed, cause the processor to:
receive the signal strength or the fading rate of the radio channel between the mobile communication radio and the base radio from the base radio; and
determine the number of audio bits for stealing based on at least the movement velocity of the mobile communication radio and the signal strength or the fading rate of the radio channel,
wherein the transmission of data bits with the voice-encoded data units on the radio channel includes an uplink transmission.

19. The mobile communication radio of claim 18, further comprising an accelerometer for determining the movement velocity of the mobile communication radio.

20. The mobile communication radio of claim 18, wherein the determined number of audio bits available for stealing is one of a first number of audio bits and a second greater number of audio bits.
